(19) United States
(12) Patent Application Publication
(10) Pub. No.: US 2020/0288910 A1
(43) Pub. Date: Sep. 17, 2020

(54) ROTISSERIE ASSEMBLIES AND METHODS OF MAKING AND USING THE SAME

(71) Applicant: KUDU SAFARI BRAAI, LLC, Springfield, MO (US)

(72) Inventors: Jeffrey Paul Broadrick, Athens, GA (US); Joseph William Pruitt, Athens, GA (US)

(21) Appl. No.: 16/815,543

(22) Filed: Mar. 11, 2020

Related U.S. Application Data
(60) Provisional application No. 62/817,417, filed on Mar. 12, 2019.

(51) Int. Cl. A47J 37/04; A47J 37/07

(52) U.S. Cl. CPC A47J 37/041; A47J 37/0786

(57) ABSTRACT

Rotisserie assemblies are disclosed. Methods of making and using rotisserie assemblies are also disclosed.

### CROSS-REFERENCE TO RELATED APPLICATIONS

This patent application claims the benefit of priority to U.S. Provisional Patent Application Ser. No. 62/817,417 filed on Mar. 12, 2019 and entitled “ROTISSERIE ASSEMBLIES AND METHODS OF MAKING AND USING THE SAME”, the subject matter of which is hereby incorporated by reference in its entirety.

### FIELD OF THE INVENTION

The present invention is directed to rotisserie assemblies. The present invention is further directed to methods of making and using rotisserie assemblies.

### BACKGROUND

Efforts continue to further develop rotisserie assemblies for use with grills such as KUDU® grills as disclosed in (1) U.S. Design Pat. Nos. D796655 and D801495, and (2) U.S. Patent Application Publication No. 2017/0303741, now, U.S. Pat. No. 10,588,455, the subject matter of all of which is herein incorporated by reference in their entirety.

### SUMMARY

The present invention contributes to the efforts to further develop rotisserie assemblies by the discovery of new rotisserie assemblies.

Accordingly, the present invention is directed to rotisserie assemblies. In one exemplary embodiment, the rotisserie assembly of the present invention comprises: a bracket that is attachable to a single rod member extending upward proximate a heat source; and a rotating rod positionable within and extending from the bracket, wherein a portion of the rotating rod is positionable over the heat source (i) while being connected to the single rod member extending upward proximate the heat source via the bracket and (ii) without being supported by any other component positioned proximate the heat source.

In another exemplary embodiment, the rotisserie assembly of the present invention comprise: a bracket that is attachable to a single rod member extending upward proximate a heat source; a rotating rod positionable within and extending from the bracket, wherein a portion of the rotating rod is positionable over the heat source (i) while being connected to the single rod member extending upward proximate the heat source via the bracket and (ii) without being supported by any other component positioned proximate the heat source; one or more prongs positionable along the rotating rod; a motor sized to rotate the rotating rod, any prongs along the rotating rod, and any food items positioned along the rotating rod; and a motor swivel bracket, the motor swivel bracket being sized and designed to be positionable between the bracket and the motor.

The present invention further relates to kits comprising the rotisserie assembly of the present invention. In one exemplary embodiment, the kit comprises the herein-described rotisserie assembly in combination with one or more additional kit component selected from: (I) a base pan member comprising: a base pan member lower wall having a pan outer periphery, and one or more side walls extending upward from said base pan member lower wall and along said pan outer periphery; (II) at least two rod members extending upward along opposite sides of said pan outer periphery; (III) a griddle that is attachable to and detachable from at least one of said at least two rod members; (IV) a grill that is attachable to and detachable from at least one of said at least two rod members; and (V) one or more ring members, each ring member comprising: a ring base having a ring outer periphery, at least two ring connectors along opposite sides of said ring outer periphery, and at least two ring tubular members extending substantially perpendicular to said ring base, said at least two ring tubular members being attached to said ring base via said at least two ring connectors; wherein each ring tubular member has a tubular diameter dun that enables said two or more ring members to be positioned and stacked along said at least two rod members.

The present invention further relates to methods of making rotisserie assemblies. In one exemplary embodiment, the method of making a rotisserie assembly comprises: forming a bracket that is attachable to a single rod member extending upward proximate a heat source; and forming a rotating rod positionable within and extending from the bracket, wherein a portion of the rotating rod is positionable over the heat source (i) while being connected to the single rod member extending upward proximate the heat source via the bracket and (ii) without being supported by any other component positioned proximate the heat source.

In another exemplary embodiment, the method of making a rotisserie assembly comprises: forming a bracket that is attachable to a single rod member extending upward proximate a heat source; forming a rotating rod positionable within and extending from the bracket, wherein a portion of the rotating rod is positionable over the heat source (i) while being connected to the single rod member extending upward proximate the heat source via the bracket and (ii) without being supported by any other component positioned proximate the heat source; forming one or more prongs positionable along the rotating rod; forming a motor sized to rotate the rotating rod, any prongs along the rotating rod, and any food items positioned along the rotating rod; and forming a motor swivel bracket, the motor swivel bracket being sized and designed to be positionable between the bracket and the motor.

The present invention even further relates to methods of using rotisserie assemblies. In one exemplary embodiment, the method of using a rotisserie assembly comprises: positioning any one of the herein-described rotisserie assemblies so that at least a portion of the rotisserie assembly is positionable over a heat source. Methods of using the rotisserie assemblies of the present invention may include, but are not limited to, any one of the following steps: incorporating one or more food items to be heated onto the rotating rod of the rotisserie assembly and/or one or more optional prongs positioned along the rotating rod; incorporating one or more food items to be heated onto the rotating rod of the rotisserie assembly and/or one or more optional prongs positioned along the rotating rod; positioning the rotating rod of the rotisserie assembly within the bracket so as to extend from a motor of the rotisserie assembly, thru the bracket, to a position opposite the motor; positioning the rotating rod so as to (i) contact an upper surface of a first rod support member of the bracket, (ii) extend within a rod-engaging member of the motor, and (iii) contact a lower surface of a second rod support member of the bracket, the second rod support member being positioned between the first rod support member and the rod-engaging member of the motor; turning “on” a motor of the rotisserie assembly, the motor being sized to rotate (i) the rotating rod of the rotisserie assembly, (ii) the one or more optional prongs along the rotating rod, and (iii) the one or more optional food items to be heated positioned along the rotating rod; and heating one or more food items over the heat source.

These and other features and advantages of the present invention will become apparent after a review of the following detailed description of the disclosed embodiments and the appended claims.

### BRIEF DESCRIPTION OF THE DRAWINGS

FIG. 1 is a side view of an exemplary rotisserie assembly of the present invention;

FIG. 2 is another side view of the exemplary rotisserie assembly shown in FIG. 1 as view from an opposite side;

FIG. 3 is a view of the exemplary rotisserie assembly shown in FIG. 2 with some of the exemplary components of the exemplary rotisserie assembly separated from one another;

FIG. 4 is a close-up side view of the exemplary bracket and the exemplary rotating rod of the exemplary rotisserie assembly shown in FIG. 2;

FIG. 5 is a close-up side view of a portion of the exemplary bracket, the exemplary rotating rod, and an exemplary prong along the exemplary rotating rod of the exemplary rotisserie assembly shown in FIG. 2;

FIG. 6 is a close-up perspective view of the exemplary bracket, the exemplary rotating rod, an exemplary motor, and an exemplary motor swivel bracket of the exemplary rotisserie assembly shown in FIG. 2;

FIG. 7 is a perspective view of the exemplary bracket of the exemplary rotisserie assembly shown in FIG. 2;

FIGS. 7A-7E depict various views of the exemplary bracket shown in FIG. 7;

FIG. 8 is a side view of the exemplary motor swivel bracket of the exemplary rotisserie assembly shown in FIG. 2;

FIGS. 8A-8B depict various views of the exemplary motor swivel bracket shown in FIG. 8;

FIG. 9 is a side view of the exemplary rotating rod of the exemplary rotisserie assembly shown in FIG. 2;

FIG. 9A depicts a view of the exemplary rotating rod shown in FIG. 9 as viewed along a length of the exemplary rotating rod from a motor-connecting end of the exemplary rotating rod;

FIG. 10 is a perspective view of an exemplary prong of the exemplary rotisserie assembly shown in FIG. 2;

FIGS. 10A-10B depict various views of the exemplary prong shown in FIG. 10;

FIG. 11 depicts a view of the exemplary rotisserie assembly shown in FIG. 2 attached to a KUDU® grill; and

FIG. 12 is a side view of two exemplary ring members that are suitable for use with the exemplary rotisserie assembly shown in FIG. 2.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to rotisserie assemblies. The present invention is further directed to methods of making rotisserie assemblies. The present invention is even further directed to methods of using rotisserie assemblies.

The rotisserie assemblies of the present invention, as well as methods of making and using the rotisserie assemblies of the present invention are further described in the following embodiments.

### Other Embodiments:

Rotisserie Assemblies

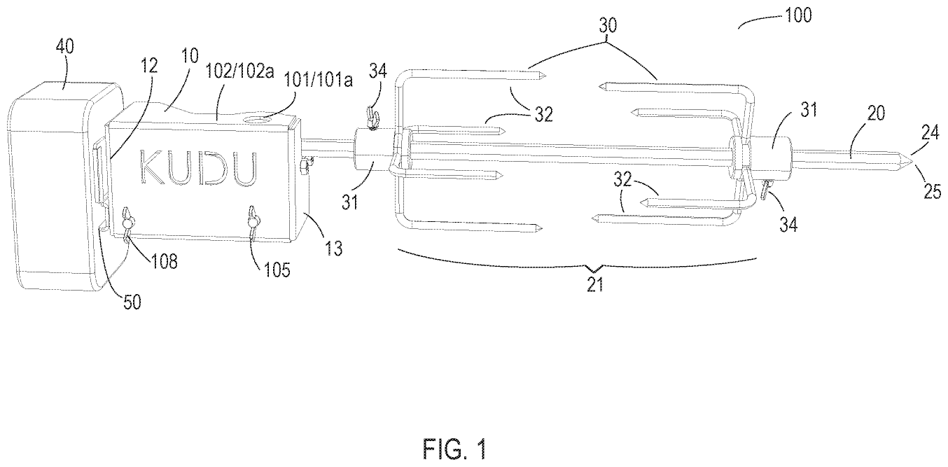

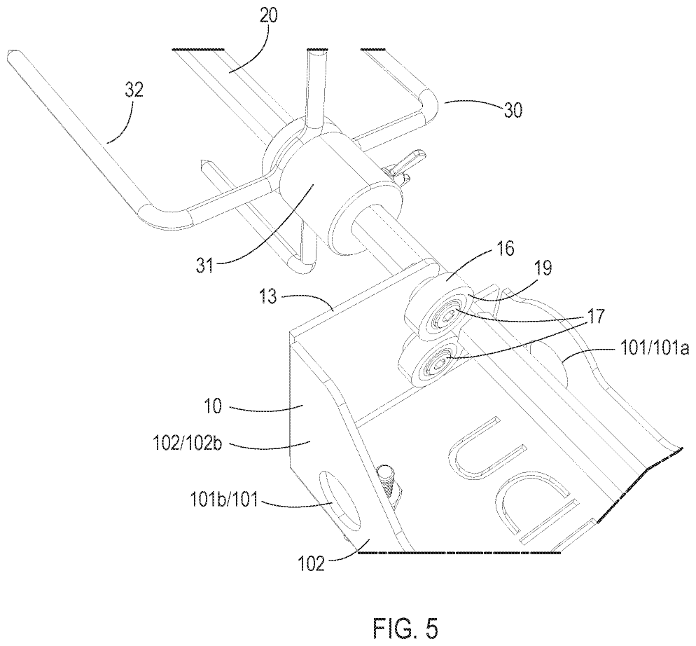

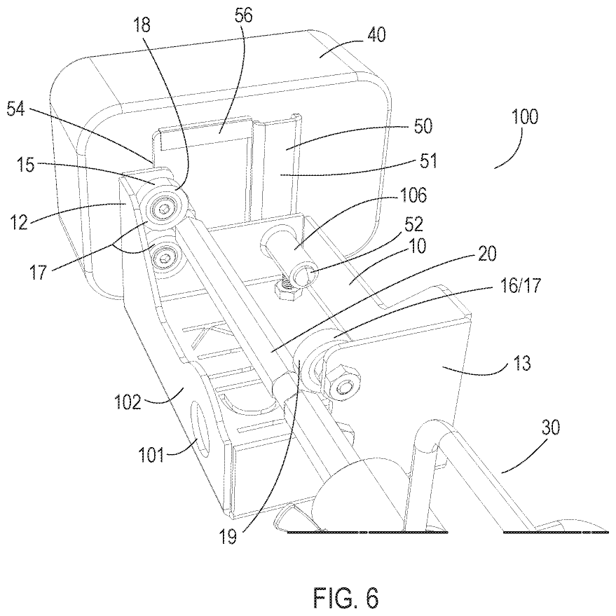

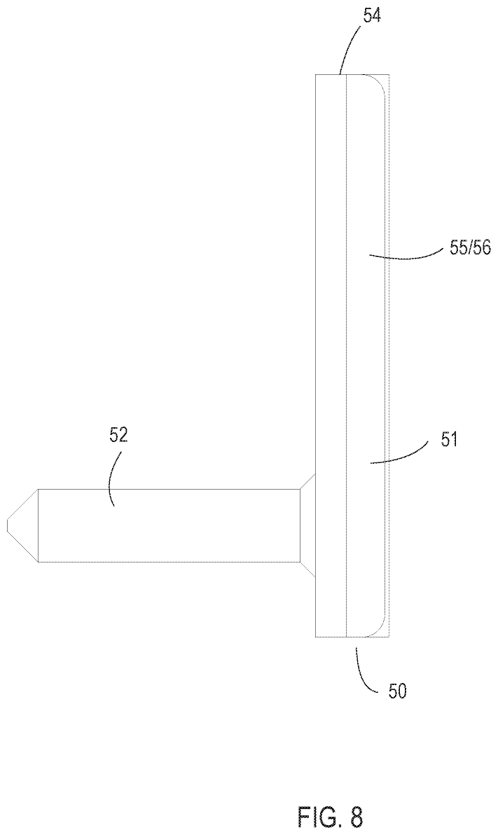

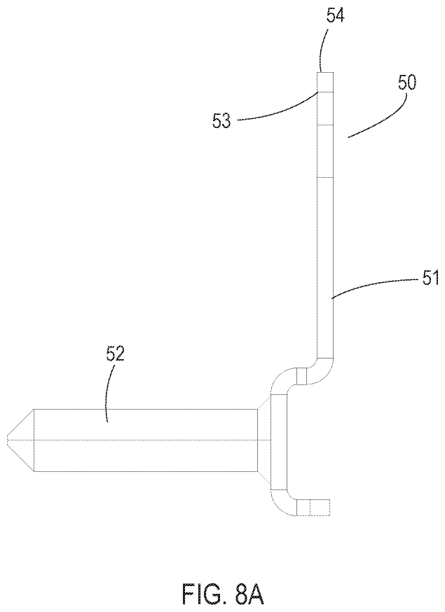

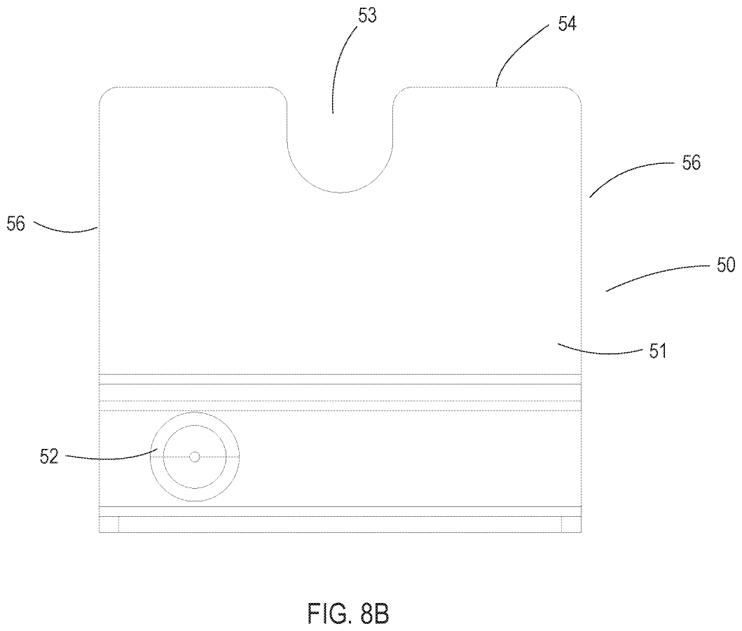

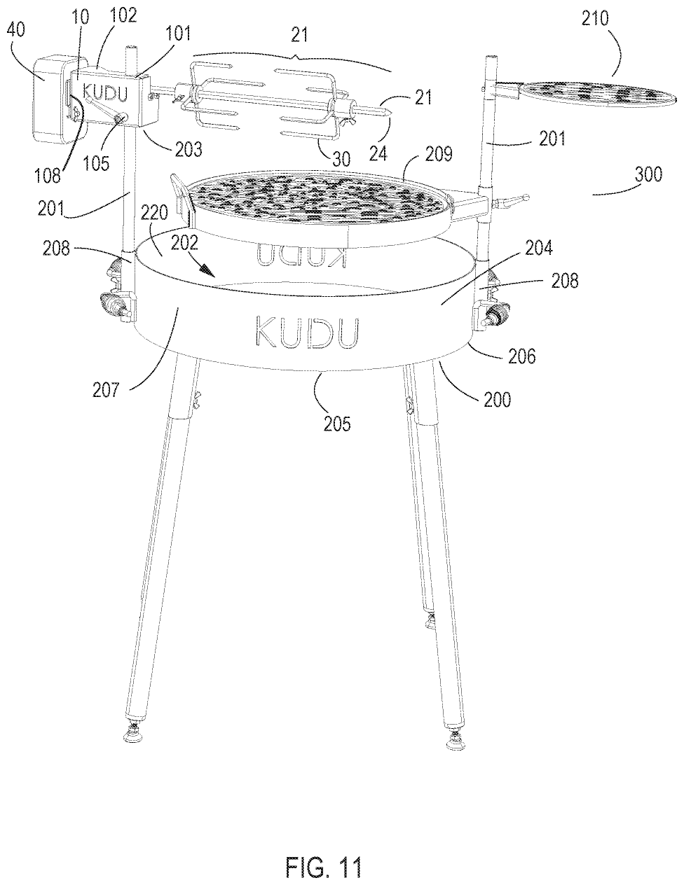

1. A rotisserie assembly 100 comprising: a bracket 10 that is attachable to a single rod member 201 extending upward proximate a heat source 202; and a rotating rod 20 positionable within and extending from the bracket 10, wherein a portion 21 of the rotating rod 20 is positionable over the heat source 202 (i) while being connected to the single rod member 201 extending upward proximate the heat source 202 via the bracket 10 and (ii) without being supported by any other component positioned proximate the heat source 202. See, for example, exemplary rotisserie assembly 100 shown in FIGS. 1-11. See also, for example, exemplary single rod member 201 extending upward proximate heat source 202 within KUDU® grill 200 shown in FIG. 11.

2. The rotisserie assembly 100 of embodiment 1, further comprising: one or more prongs 30 positionable along the rotating rod 20. See, for example, exemplary prongs 30 shown in FIGS. 1-3 and 10-11.

3. The rotisserie assembly 100 of embodiment 2, wherein each prong 30 comprises (i) a prong base 31, and (ii) two or more prong stakes 32 extending from the prong base 31.

4. The rotisserie assembly 100 of embodiment 3, wherein each prong 30 comprises four prong stakes 32 extending from the prong base 31.

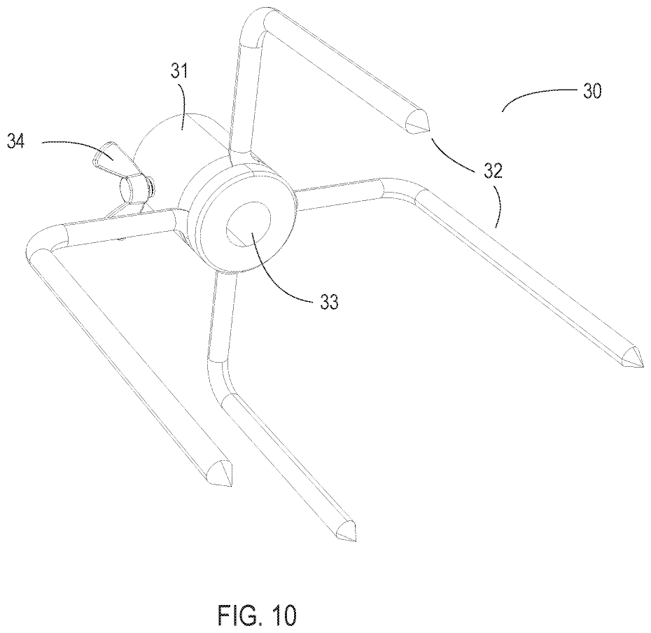

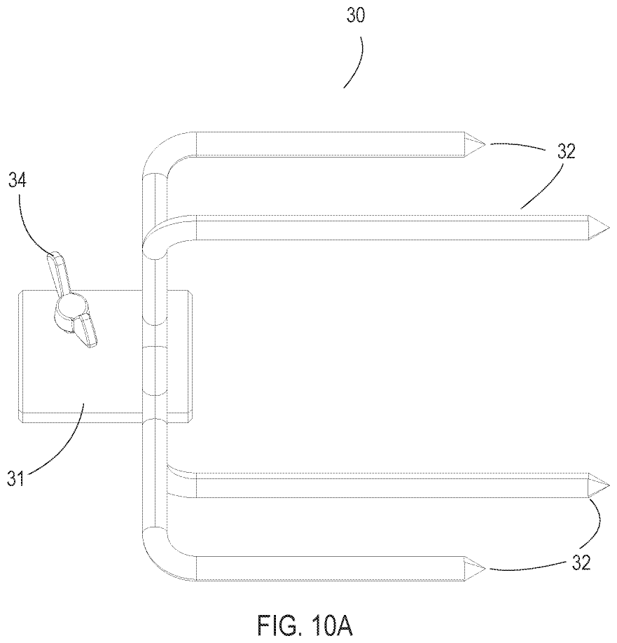

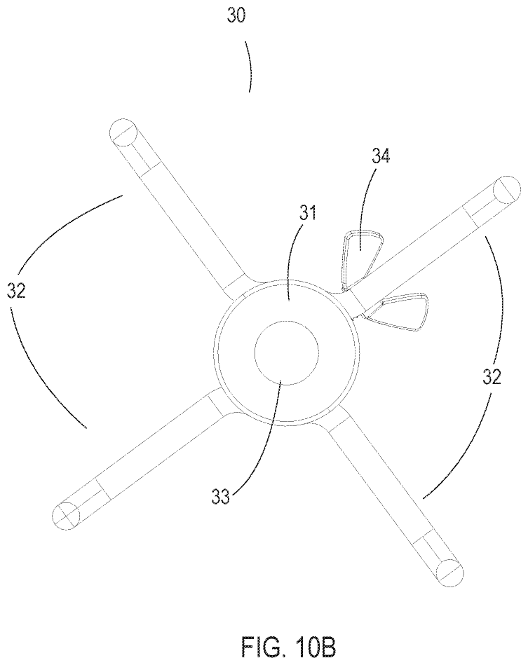

5. The rotisserie assembly 100 of embodiment 3 or 4, wherein each prong base 31 comprises a hole 33 extending therethough, said hole 33 being sized so that a given prong 30 is extendable over and along an outer surface 22 of the rotating rod 20. See, for example, exemplary prongs 30 shown in FIGS. 10-10B.

6. The rotisserie assembly 100 of any one of embodiments 2 to 5, wherein each prong 30 further comprises a prong locking device 34. See again, for example, exemplary prongs 30 shown in FIGS. 1-3 and 10-11.

7. The rotisserie assembly 100 of embodiment 6, wherein said prong locking device 34 comprises a first locking screw 34.

8. The rotisserie assembly 100 of any one of embodiments 2 to 7, wherein the one or more prongs 30 are positioned along and movable along the rotating rod 20.

9. The rotisserie assembly 100 of any one of embodiments 2 to 8, wherein the one or more prongs 30 are positioned along and movable along the portion 21 of the rotating rod 20 that is positionable over the heat source 202.

10. The rotisserie assembly 100 of any one of embodiments 2 to 9, wherein the one or more prongs 30 comprise two separate prongs 30.

11. The rotisserie assembly 100 of any one of embodiments 1 to 10, further comprising: a motor 40 sized to rotate the rotating rod 20, any prongs 30 along the rotating rod 20, and any food items (not shown) positioned along the rotating rod 20.

12. The rotisserie assembly 100 of embodiment 11, wherein (i) the motor 40 is positioned along a first side 12 of said bracket 10, and (ii) the portion 21 of the rotating rod 20 that is positionable over the heat source 202 is positioned along a second side 13 of said bracket 10, said second side 13 being opposite said first side 12.

13. The rotisserie assembly 100 of any one of embodiments 1 to 10, wherein said rotating rod 20 comprises (i) a motor-engaging end 23 and (ii) a tip end 24 opposite the motor-engaging end 23, said tip end 24 being unsupported by anything other than said bracket 10. See, for example, exemplary rotating rod 20 shown in FIGS. 1-3 and 9-9A.

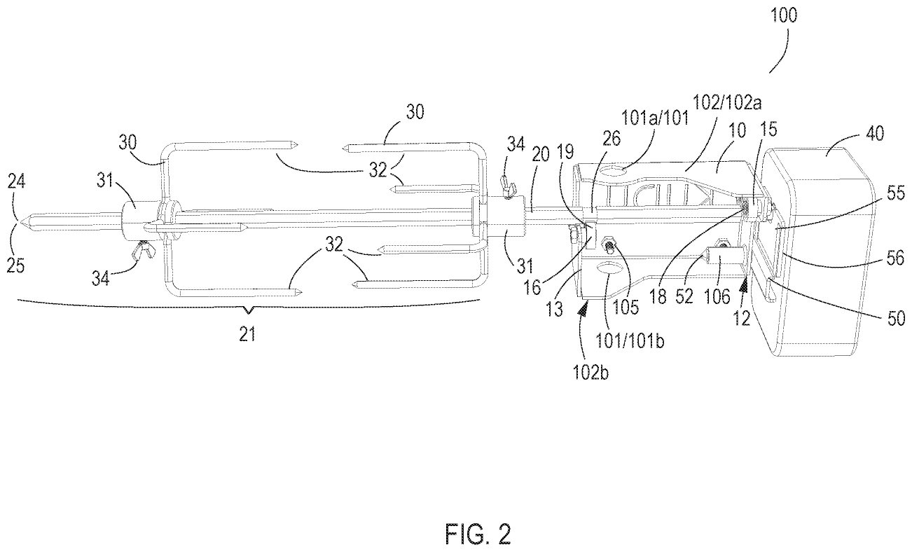

14. The rotisserie assembly 100 of any one of embodiments 1 to 13, wherein said bracket 10 comprises (i) a first rotating rod support member 15 proximate a first side 12 of said bracket 10, and (ii) a second rotating rod support member 16 proximate an opposite second side 13 of said bracket 10. See, for example, exemplary first rotating rod support member 15 and exemplary second rotating rod support member 16 shown in FIGS. 2-6.

15. The rotisserie assembly 100 of embodiment 14, wherein each of (i) the first rotating rod support member 15, and (ii) the second rotating rod support member 16 comprises a set of bearings 17. See again, for example, each of exemplary first rotating rod support member 15 and exemplary second rotating rod support member 16 in the form of a pair of bearings 17 shown in FIGS. 2-6.

16. The rotisserie assembly 100 of embodiment 14 or 15, wherein said rotating rod 20 is positionable within the bracket 10 so as to (i) extend within a rod-engaging member 41 of the motor 40, (ii) contact a lower surface 18 of the first rotating rod support member 15, (iii) contact an upper surface 19 of the second rotating rod support member 16, and (iv) exit said bracket 10 so that the portion 21 of the rotating rod 20 that is positionable over the heat source 202 is opposite the motor 40. See again, FIGS. 2-6.

17. The rotisserie assembly 100 of any one of embodiments 1 to 16, wherein said bracket 10 comprises at least one rod-engaging hole 101 within an outer surface 102 of the bracket 10, each of the at least one rod-engaging hole 101 being sized to accept the single rod member 201 extending upward proximate the heat source 202. See again, for example, each exemplary rod-engaging hole 101 shown in FIGS. 1-7A, 7E and 11.

18. The rotisserie assembly 100 of any one of embodiments 1 to 17, wherein said bracket 10 comprises two rod-engaging holes 101 within an outer surface 102 of the bracket 10, each of the two rod-engaging hole 101 being sized to accept the single rod member 201 extending upward proximate the heat source 202.

19. The rotisserie assembly 100 of embodiment 18, wherein the two rod-engaging holes 201 of the bracket 10 comprise a first rod-engaging hole 101a within an upper outer surface 102a of the bracket 10, and a second rod-engaging hole 101b within a lower outer surface 102b of the bracket 10.

20. The rotisserie assembly 100 of embodiment 19, wherein the two rod-engaging holes 101 of the bracket 10 are positioned proximate the second side 13 of said bracket 10, away from the motor 40.

21. The rotisserie assembly 100 of any one of embodiments 1 to 20, wherein said bracket 10 further comprises a bracket locking device 105, said bracket locking device 105 enabling the bracket 10 and the rotisserie assembly 100 to be attached at a location 203 along the single rod member 201. See, for example, exemplary bracket locking device 105 shown in FIGS. 1-2 and 4.

22. The rotisserie assembly 100 of embodiment 21, wherein said bracket locking device 105 comprises a second locking screw 105.

23. The rotisserie assembly 100 of any one of embodiments 11 to 22, further comprising: a motor swivel bracket 50, said motor swivel bracket 50 being sized and designed to be positionable between the bracket 10 and the motor 40. See, for example, exemplary motor swivel bracket 50 shown in FIGS. 1-4, 6 and 8-8B.

24. The rotisserie assembly 100 of embodiment 23, wherein said motor swivel bracket 50 comprises (i) a motor swivel bracket base member 51, and (ii) a male connector 52 extending from the motor swivel bracket base member 51, said male connector 52 being sized and designed so as to engage with a corresponding female connector 106 on said bracket 10.

25. The rotisserie assembly 100 of embodiment 24, wherein said motor swivel bracket 50 further comprises a cutout 53 along an upper edge 54 of the motor swivel bracket base member 51, said cutout 53 being sized so that the motor-engaging end 23 of the rotating rod 20 can extend therethrough.

26. The rotisserie assembly 100 of embodiment 24 or 25, wherein said motor swivel bracket 50 further comprises one or more connecting features 55 that enable said motor swivel bracket 50 to be connected to said motor 40. The one or more connecting features 55 may comprise any material/feature that enables connection of motor swivel bracket 50 to motor 40. Suitable materials/features include, but are not limited to, a weld, a mechanical fastener (e.g., screw, screw hole, an engaging edge, etc.), an adhesive, etc.

27. The rotisserie assembly 100 of embodiment 26, wherein said one or more connecting features 55 comprise two connecting features 55 extending along opposite side edges 56 of said motor swivel bracket 50.

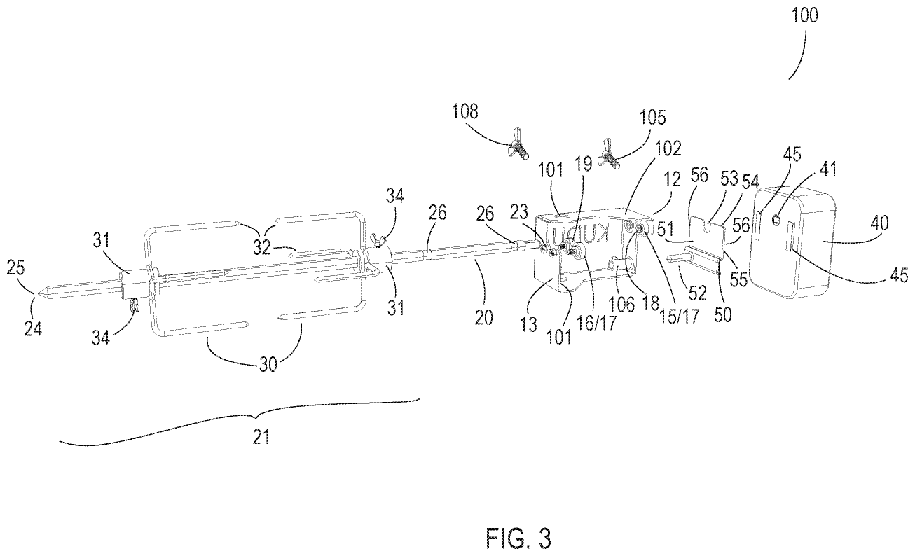

28. The rotisserie assembly 100 of any one of embodiments 23 to 27, wherein said motor 40 further comprises one or more motor connecting features 45 that enable the motor 40 to be connected to the motor swivel bracket 50. See, FIG. 3.

29. The rotisserie assembly 100 of embodiment 27 or 28, wherein said motor 40 further comprises one or more motor connecting features 45 that enable the motor 40 to be connected to the motor swivel bracket 50 via the two connecting features 55 extending along opposite side edges 56 of said motor swivel bracket 50.

30. The rotisserie assembly 100 of any one of embodiments 24 to 29, wherein said bracket 10 further comprises a corresponding female connector 106 that engages with the male connector 52 extending from the motor swivel bracket base member 51.

31. The rotisserie assembly 100 of embodiment 30, wherein said corresponding female connector 106 comprises a channel 106′ extending into said bracket 10 from the first side 15 of the bracket 10.

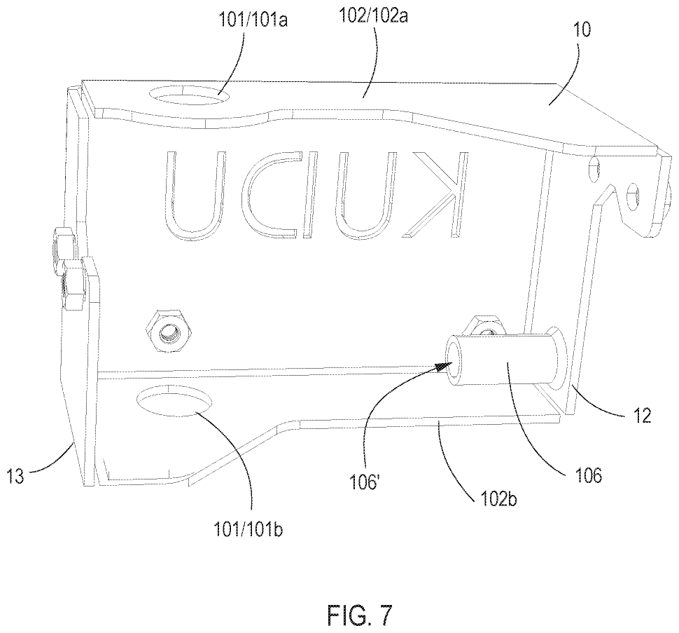

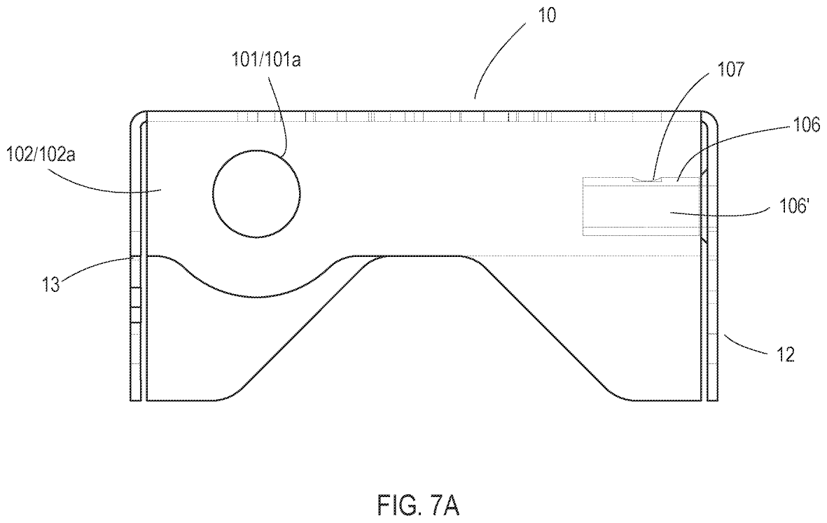

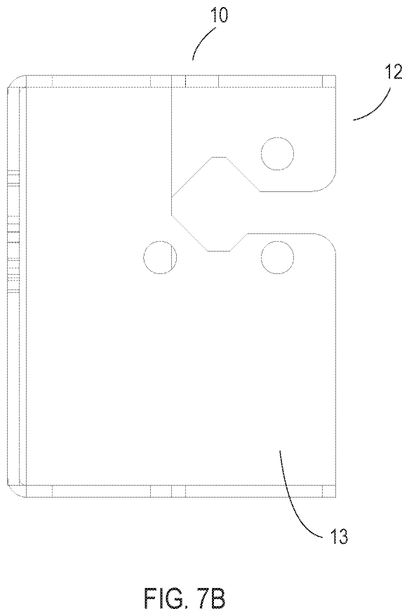

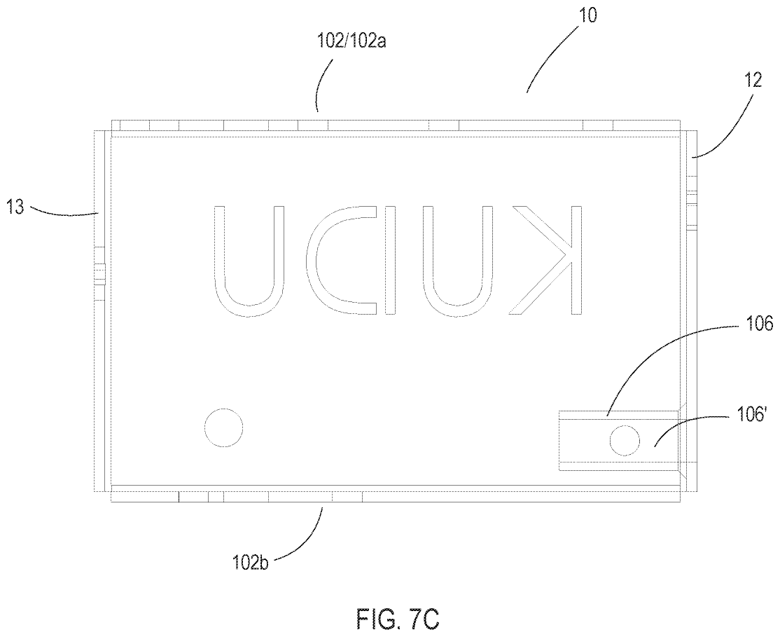

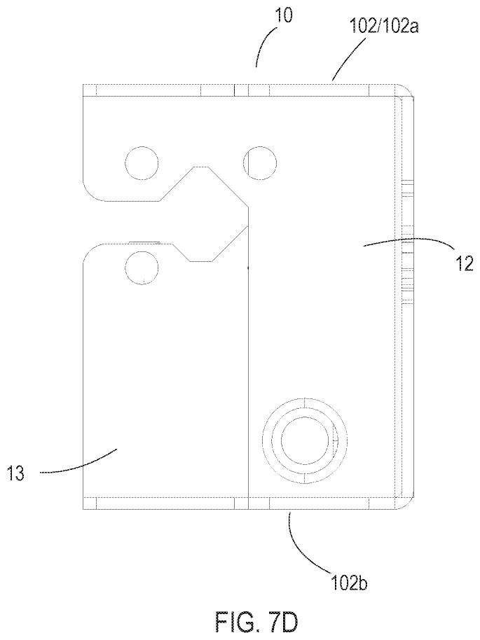

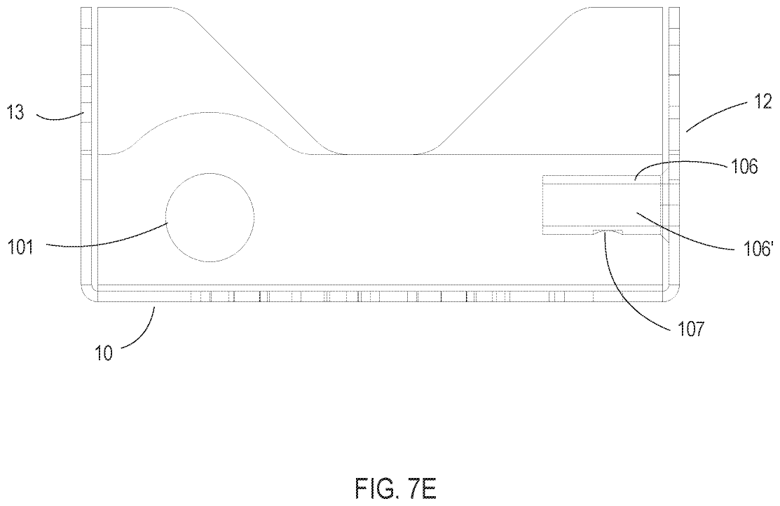

32. The rotisserie assembly 100 of embodiment 31, wherein said channel 106′ comprises a side opening 107 sized so that a motor swivel bracket locking device 108 can extend through the side opening 107 into the channel 106′. See, for example, FIGS. 7A and 7E.

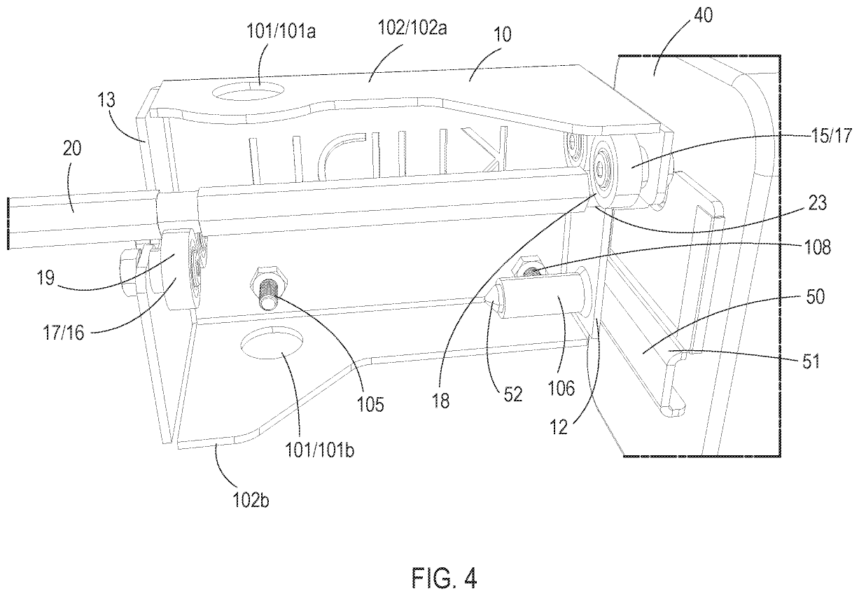

33. The rotisserie assembly 100 of embodiment 32, wherein said bracket 10 further comprises a motor swivel bracket locking device 108, said motor swivel bracket locking device 108 enabling the motor swivel bracket 50 and the bracket 10 to be attached to one another. See, for example, FIGS. 1 and 4.

34. The rotisserie assembly 100 of embodiment 33, wherein said motor swivel bracket locking device 108 comprises a third locking screw 108.

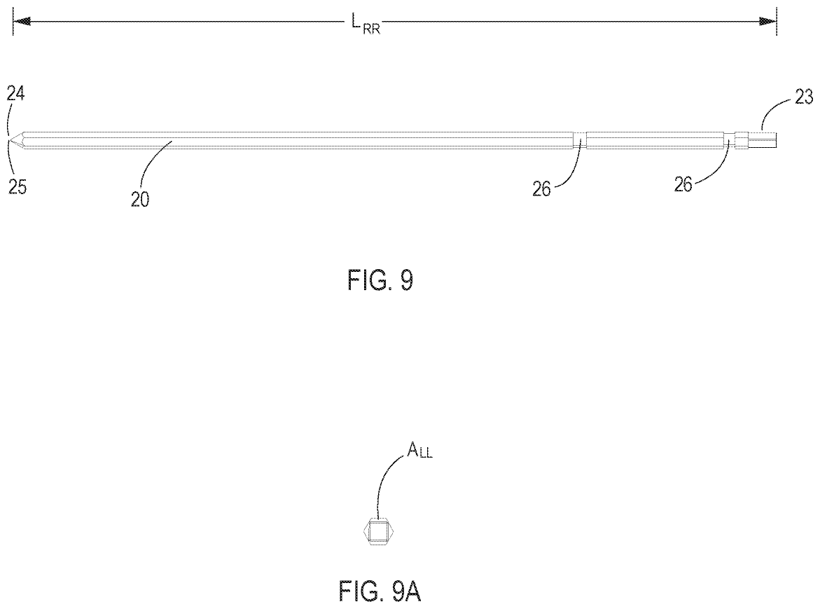

35. The rotisserie assembly 100 of any one of embodiments 1 to 34, wherein said rotating rod 20 comprises (i) a rotating rod length L_{RR} and (ii) a rotating rod cross-sectional area A_{RR} that changes long the rotating rod length L_{RR}. See, for example, FIGS. 9 and 9A. It should be understood that each of the components within the rotisserie assembly 100 of the present invention may have any dimensions. Typically, the rotating rod 20 has a rotating rod length L_{RR} ranging from about 6.0 inches (in.) to about 42.0 in. Typically, the rotisserie assembly 100 has an overall length ranging from about 8.0 in. to about 50.0 in.

36. The rotisserie assembly 100 of any one of embodiments 13 to 35, wherein the motor-engaging end 23 of said rotating rod 20 comprises a rotating rod cross-sectional area A_{RR} having a cross-sectional shape other than a circular shape. As shown in FIG. 9A, exemplary motor-engaging end 23 of rotating rod 20 has a cross-sectional area A_{RR} shape in the form of a square shape.

37. The rotisserie assembly 100 of any one of embodiments 13 to 36, wherein the motor-engaging end 23 of said rotating rod 20 comprises a rotating rod cross-sectional area A_{RR} having a cross-sectional shape selected from a triangular shape, a square shape, a rectangular shape, a star shape, or any other multi-sided shape.

38. The rotisserie assembly 100 of any one of embodiments 13 to 37, wherein the motor-engaging end 23 of said rotating rod 20 comprises a rotating rod cross-sectional area A_{RR} having a square cross-sectional shape.

39. The rotisserie assembly 100 of any one of embodiments 13 to 37, wherein the tip end 24 of said rotating rod 20 comprises an end point 25 that is capable of penetrating a food item (not shown).

40. The rotisserie assembly 100 of any one of embodiments 14 to 37, wherein contact portions 26 of said rotating rod 20 that come into contact with (i) the first rotating rod support member 15, and (ii) the second rotating rod support member 16 comprise a rotating rod cross-sectional area A_{RR} having a circular cross-sectional shape. See again, FIG. 9.

41. The rotisserie assembly 100 of any one of embodiments 35 to 40, wherein a majority of the rotating rod length L_{RR} (i.e., greater than 50%) comprises a rotating rod cross-sectional area A_{RR} that has a cross-sectional shape other than a circular shape. See again, FIG. 9.

42. The rotisserie assembly 100 of any one of embodiments 35 to 41, wherein a majority of the rotating rod length L_{RR} comprises a rotating rod cross-sectional area A_{RR} that has a square cross-sectional shape or a hexagonal cross-sectional shape.

43. The rotisserie assembly 100 of any one of embodiments 35 to 42, wherein a majority of the rotating rod length L_{RR} comprises a rotating rod cross-sectional area A_{RR} that has a hexagonal cross-sectional shape.

44. The rotisserie assembly 100 of any one of embodiments 1 to 43, in combination with the single rod member 201 extending upward proximate a heat source 202.

45. The rotisserie assembly 100 of any one of embodiments 1 to 44, wherein the heat source 202 comprises charcoal or other combustible material (not shown) positioned within a grill 200 or fire pit 200.

46. The rotisserie assembly 100 of any one of embodiments 1 to 45, in combination with a KUDU® grill 200 (or any grill/fire pit 200 shown and/or described in (1) U.S. Design Pat. Nos. D796655 and D801495, and/or (2) U.S. Patent Application Publication No. 2017/0303741).

47. The rotisserie assembly 100 of any one of embodiments 1 to 46, in combination with and attached to the single rod member 201 extending upward proximate a heat source 202, the single rod member 201 extending upward proximate a heat source 202 comprises a rod component 201 of a KUDU® grill 200 (or any grill/fire pit 200 shown and/or described in (1) U.S. Design Pat. Nos. D796655 and D801495, and/or (2) U.S. Patent Application Publication No. 2017/0303741).

48. The rotisserie assembly 100 of embodiment 46 or 47, wherein the rotisserie assembly 100 is rotatable along the single rod member 201 so that the portion 21 of the rotating rod 20 that is positionable over the heat source 202 can be rotated from (i) a position over the heat source 202 to (ii) a position not over the heat source 202, and vice versa.

Kits Comprising A Rotisserie Assembly

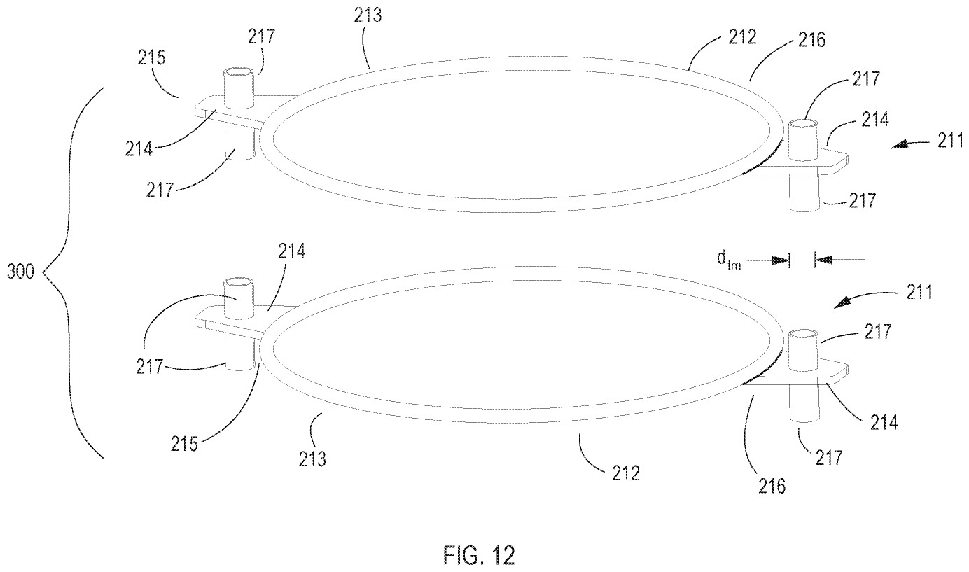

49. A kit 300 comprising the rotisserie assembly 100 of any one of embodiments 1 to 48; and at least one additional kit component selected from: (I) a base pan member 204 comprising: a base pan member lower wall 205 having a pan outer periphery 206, and one or more side walls 207 (typically, from 1 to 16, more typically, from 4 to 8 side walls 207) extending upward from said base pan member lower wall 205 and along said pan outer periphery 206; (II) at least one (typically two) rod members 201 extending upward along opposite sides 208 of said pan outer periphery 206; (III) a griddle 209 that is attachable to and detachable from at least one of said at least two rod members 201; (IV) a grill 210 that is attachable to and detachable from at least one of said at least two rod members 201; and (V) one or more ring members 211 (FIG. 12) each ring member 211 comprising: a ring base 212 having a ring outer periphery 213, at least two ring connectors 214 along opposite sides 215/216 of said ring outer periphery 213, and at least two ring tubular members 217 extending substantially perpendicular to said ring base 212, said at least two ring tubular members 217 being attached to said ring base 212 via said at least two ring connectors 214; wherein each ring tubular member 217 has a tubular diameter dun that enables said one or more ring members 211 to be positioned and stacked along said at least two rod members 201. See, for example, FIGS. 11-12.

Methods of Using Rotisserie Assemblies

50. A method of using the rotisserie assembly 100 of any one of embodiments 1 to 48, said method comprising: positioning the rotisserie assembly 100 so that at least a portion 21 of the rotisserie assembly 100 is positionable over a heat source 202.

51. The method of embodiment 50, wherein the portion 21 of the rotisserie assembly 100 that is positionable over the heat source 202 comprises a rotating rod 20 of the rotisserie assembly 100 and one or more optional prongs 30 positioned along the rotating rod 20.

52. The method of embodiment 50 or 51, further comprising: incorporating one or more food items to be heated (not shown) onto the rotating rod 20 and/or one or more optional prongs 30 positioned along the rotating rod 20.

53. The method of any one of embodiments 50 to 52, further comprising: incorporating one or more prongs 30 onto the rotating rod 20 of the rotisserie assembly 100.

54. The method of any one of embodiments 50 to 53, further comprising: moving one or more prongs 30 along the rotating rod 20 of the rotisserie assembly 100.

55. The method of any one of embodiments 50 to 54, further comprising: locking one or more prongs 30 in set positions along the rotating rod 20 of the rotisserie assembly 100.

56. The method of any one of embodiments 50 to 55, further comprising: unlocking one or more prongs 30 so as to be movable along the rotating rod 20 of the rotisserie assembly 100.

57. The method of any one of embodiments 50 to 56, further comprising: removing one or more prongs 30 from the rotating rod 20 of the rotisserie assembly 100.

58. The method of any one of embodiments 50 to 57, wherein the one or more prongs 30 (or optional prongs 30) comprise two separate prongs 30.

59. The method of any one of embodiments 50 to 58, further comprising: positioning the rotating rod 20 of the rotisserie assembly 100 within the bracket 10 so as to extend from a motor 40 of the rotisserie assembly 100, thru the bracket 10, to a position 21 opposite the motor 40.

60. The method of embodiment 59, wherein said positioning the rotating rod 20 comprises: positioning the rotating rod 20 so as to (i) contact a lower surface 18 of a first rod support member 15 of the bracket 10, (ii) extend within a rod-engaging member 41 of the motor 40, and (iii) contact an upper surface 19 of a second rod support member 16 of the bracket 10, the first rod support member 15 being positioned between the second rod support member 16 and the rod-engaging member 41 of the motor 40.

61. The method of embodiment 60, wherein the rotating rod 20 has one or more prongs 30 positioned along the rotating rod 20.

62. The method of embodiment 60 or 61, wherein the rotating rod 20 has one or more food items to be heated (not shown) positioned along the rotating rod 20.

63. The method of any one of embodiments 50 to 62, further comprising: turning “on” a motor 40 of the rotisserie assembly 100, the motor 40 being sized to rotate (i) the rotating rod 20 of the rotisserie assembly 100, (ii) the one or more optional prongs 30 along the rotating rod 20, and (iii) the one or more optional food items to be heated (not shown) positioned along the rotating rod 20.

64. The method of any one of embodiments 50 to 63, further comprising: heating one or more food items (not shown) over the heat source 202.

65. The method of any one of embodiments 50 to 64, wherein said positioning step comprises: attaching the bracket 10 of the rotisserie assembly 100 to a single rod member 201 extending upward along an outer edge 220 of the heat source 202.

66. The method of any one of embodiments 50 to 65, wherein said positioning step comprises: attaching the bracket 10 of the rotisserie assembly 100 to a single rod member 201 of a KUDU® grill 200 (or any grill/fire pit 200 shown and/or described in (1) U.S. Design Pat. Nos. D796655 and D801495, and/or (2) U.S. Patent Application Publication No. 2017/0303741).

67. The method of embodiment 65 or 66, wherein said attaching step enables the rotisserie assembly 100 to rotate along the single rod member 201 so that the portion 21 of the rotisserie assembly 100 that is positionable over the heat source 202 can be rotated from (i) a position over the heat source 202 to (ii) a position not over the heat source 202, and vice versa.

68. The method of any one of embodiments 65 to 67, wherein said attaching step enables the portion 21 of the rotisserie assembly 100 that is positionable over the heat source 202 to be suspended over the heat source 202 without having to support a free end (i.e., tip end 24) of the rotating rod 20 (i.e., as shown in the figures, the rotisserie assembly 100 of the present invention is not supported on each end, but instead is supported solely by the bracket 10 of the rotisserie assembly 100, namely, a single support along one edge 220 of the heat source 202, not two as customarily used in known rotisserie systems).

69. The method of any one of embodiments 65 to 68, wherein said attaching step comprises extending the single rod member 201 thru at least one rod-engaging hole 101 within the bracket 10 of the rotisserie assembly 100.

70. The method of any one of embodiments 65 to 69, wherein said attaching step comprises extending the single rod member 201 thru two rod-engaging holes 101 within the bracket 10 of the rotisserie assembly 100.

71. The method of embodiment 70, wherein the two rod-engaging holes 101 of the bracket 10 comprise a first rod-engaging hole 101a within an upper outer surface 102a of the bracket 10, and a second rod-engaging hole 101b within a lower outer surface 102b of the bracket 10.

72. The method of any one of embodiments 65 to 71, further comprising: removing the rotisserie assembly 100 from the single rod member 201.

Methods of Making Rotisserie Assemblies

73. A method of making the rotisserie assembly 100 of any one of embodiments 1 to 48 or the kit 200 of embodiment 49, said method comprising: forming the bracket 10; and forming the rotating rod 20.

74. The method of embodiment 73, wherein said method comprises forming the one or more prongs 30 positionable along the rotating rod 20.

75. The method of embodiment 73 or 74, wherein said method comprises forming the motor 40 sized to rotate the rotating rod 20, any prongs 30 along the rotating rod 20, and any food items (not shown) positioned along the rotating rod 20.

76. The method of any one of embodiments 73 to 75, wherein said method comprises forming the motor swivel bracket 50, the motor swivel bracket 50 being sized and designed to be positionable between the bracket 10 and the motor 40.

77. The method of any one of embodiments 73 to 76, wherein each forming step independently comprises at least one of: a machining step, a stamping step, a welding step, a cutting step, a thermoforming step (e.g., molding, injection molding, extruding, etc.), a heat-setting step, an assembling step, a testing step, or any combination thereof.

It should be understood that although the above-described rotisserie assemblies, kits and methods are described as “comprising” one or more components or steps, the above-described rotisserie assemblies, kits and methods may “comprise,” “consists of,” or “consist essentially of” any of the above-described components or steps of the rotisserie assemblies, kits and/or methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a rotisserie assembly, kit and/or method that “comprises” a list of elements (e.g., components or steps) is not necessarily limited to only those elements (or components or steps), but may include other elements (or components or steps) not expressly listed or inherent to the rotisserie assembly, kit and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a protective rotisserie assembly, kit and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described rotisserie assemblies, kits and/or methods may comprise, consist essentially of, or consist of any of the herein-described components and features, as shown in the figures with or without any feature(s) not shown in the figures. In other words, in some embodiments, the rotisserie assemblies, kits and/or methods of the present invention do not have any additional features other than those shown in the figures, and such additional features, not shown in the figures, are specifically excluded from the rotisserie assemblies, kits and/or methods. In other embodiments, the rotisserie assemblies, kits and/or methods of the present invention do have one or more additional features that are not shown in the figures.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

Rotisserie assemblies and kits, similar to exemplary rotisserie assemblies 100 and exemplary kit 300 shown in FIGS. 1-12, were prepared.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A rotisserie assembly comprising:
a bracket that is attachable to a single rod member extending upward proximate a heat source; and
a rotating rod positionable within and extending from the bracket,
wherein a portion of the rotating rod is positionable over the heat source (i) while being connected to the single rod member extending upward proximate the heat source via the bracket and (ii) without being supported by any other component (a) positioned proximate the heat source and (b) positioned opposite the bracket.

2. The rotisserie assembly of claim 1, further comprising:
one or more prongs positionable along the rotating rod, wherein each prong comprises (i) a prong base, and (ii) two or more prong stakes extending from the prong base.

3. The rotisserie assembly claim 2, wherein each prong base comprises a hole extending therethough, said hole being sized so that a given prong is extendable over and along an outer surface of the rotating rod.

4. The rotisserie assembly of claim 2, wherein the one or more prongs are positioned along and movable along the portion of the rotating rod that is positionable over the heat source.

5. The rotisserie assembly of claim 2, wherein the one or more prongs comprise two separate prongs.

6. The rotisserie assembly of claim 1, further comprising:
a motor sized to rotate the rotating rod, any prongs along the rotating rod, and any food items positioned along the rotating rod.

7. The rotisserie assembly of claim 6, wherein (i) the motor is positioned along a first side of said bracket, and (ii) the portion of the rotating rod that is positionable over the heat source is positioned along a second side of said bracket, said second side being opposite said first side.

8. The rotisserie assembly of claim 1, wherein said rotating rod comprises (i) a motor-engaging end and (ii) a tip end opposite the motor-engaging end, said tip end being unsupported by anything other than said bracket.

9. The rotisserie assembly of claim 1, wherein said bracket comprises (i) a first rotating rod support member proximate a first side of said bracket, and (ii) a second rotating rod support member proximate an opposite second side of said bracket,
wherein said rotating rod is positionable within the bracket so as to (i) extend within a rod-engaging member of the motor, (ii) contact a lower surface of the first rotating rod support member, (iii) contact an upper surface of the second rotating rod support member, and (iv) exit said bracket so that the portion of the rotating rod that is positionable over the heat source is opposite the motor.

10. The rotisserie assembly of claim 9, wherein each of (i) the first rotating rod support member, and (ii) the second rotating rod support member comprises a set of bearings.

11. The rotisserie assembly of claim 1, wherein said bracket comprises at least one rod-engaging hole within an outer surface of the bracket, each of the at least one rod-engaging hole being sized to accept the single rod member extending upward proximate the heat source.

12. The rotisserie assembly of claim 1, wherein said bracket comprises two rod-engaging holes within an outer surface of the bracket, each of the two rod-engaging hole being sized to accept the single rod member extending upward proximate the heat source, wherein the two rod-engaging holes of the bracket comprise a first rod-engaging hole within an upper outer surface of the bracket, and a second rod-engaging hole within a lower outer surface of the bracket.

13. The rotisserie assembly of claim 1, wherein said bracket further comprises a bracket locking device, said bracket locking device enabling the bracket and the rotisserie assembly to be attached at a location along the single rod member.

14. The rotisserie assembly of claim 6, further comprising:
a motor swivel bracket, said motor swivel bracket being sized and designed to be positionable between the bracket and the motor.

15. The rotisserie assembly of claim 14, wherein said motor swivel bracket further comprises a cutout along an upper edge of the motor swivel bracket base member, said cutout being sized so that the motor-engaging end of the rotating rod can extend therethrough.

16. The rotisserie assembly of claim 1, in combination with a KUDU grill or any grill/fire pit shown and/or described in (1) U.S. Design Pat. Nos. D796655 and D801495, and/or (2) U.S. Patent Application Publication No. 2017/0303741.

17. The rotisserie assembly of claim 1, in combination with one or more rod members, each rod members being operatively adapted to extend upward proximate a heat source, and comprising a rod component of a KUDU° grill or any grill/fire pit shown and/or described in (1) U.S. Design Pat. Nos. D796655 and D801495, and/or (2) U.S. Patent Application Publication No. 2017/0303741.

18. A kit comprising the rotisserie assembly of claim 1; and at least one additional kit component selected from:
(I) a base pan member comprising:
a base pan member lower wall having a pan outer periphery, and
from one to sixteen side walls extending upward from said base pan member lower wall and along said pan outer periphery;
(II) at least two rod members, each of which is attachable to so as to extend upwardly along opposite sides of said pan outer periphery;
(III) a griddle that is attachable to and detachable from at least one of said at least two rod members;
(IV) a grill that is attachable to and detachable from at least one of said at least two rod members; and
(V) one or more ring members, each ring member comprising:
a ring base having a ring outer periphery,
at least two ring connectors along opposite sides of said ring outer periphery, and
at least two ring tubular members extending substantially perpendicular to said ring base, said at least two ring tubular members being attached to said ring base via said at least two ring connectors;
wherein each ring tubular member has a tubular diameter dun that enables said one or more ring members to be positioned and stacked along said at least two rod members.

19. A rotisserie assembly comprising:
a bracket that is attachable to a single rod member extending upward proximate a heat source;
a rotating rod positionable within and extending from the bracket, wherein a portion of the rotating rod is positionable over the heat source (i) while being connected to the single rod member extending upward proximate a heat source via the bracket and (ii) without being supported by any other component (a) positioned proximate the heat source and (b) positioned opposite the bracket;
two or more prongs positionable along and movable along the rotating rod, wherein each prong comprises (i) a prong base, and (ii) two or more prong stakes extending from the prong base; and
a motor sized to rotate the rotating rod, any prongs along the rotating rod, and any food items positioned along the rotating rod,
wherein said bracket comprises (i) a first rotating rod support member proximate a first side of said bracket, and (ii) a second rotating rod support member proximate an opposite second side of said bracket, and
wherein said rotating rod is positionable within the bracket so as to (i) extend within a rod-engaging member of the motor, (ii) contact a lower surface of the first rotating rod support member, (iii) contact an upper surface of the second rotating rod support member, and (iv) exit said bracket so that the portion of the rotating rod that is positionable over the heat source is opposite the motor.

20. A method of using the rotisserie assembly of claim 19, said method comprising:
positioning the rotating rod so as to (i) contact an upper surface of a first rod support member of the bracket, (ii) extend within a rod-engaging member of the motor, and (iii) contact a lower surface of a second rod support member of the bracket, the second rod support member being positioned between the first rod support member and the rod-engaging member of the motor.
